(19) United States
(12) Patent Application Publication
(10) Pub. No.: US 2004/0175065 A1
(43) Pub. Date: Sep. 9, 2004

(54) Ball bearing assembly utilizing a labyrinth seal

(75) Inventor: Tien Vinh Nguyen, Santa Ana, CA (US)

Correspondence Address: Stuart B. Chinn, PILLSBURY WINTHROP LLP, Ste. 2800, 725 South Figueroa St., Los Angeles, CA, 90017, US

(73) Assignee: MINEBEA CO., LTD., Tokyo (JP)

(21) Appl. No.: 10/384,261

(22) Filed: Mar. 7, 2003

(51) Int. Cl. F16C 33/80

(52) U.S. Cl. 384/480

(57) ABSTRACT

A self-contained labyrinth seal ball bearing assembly includes at least one labyrinth seal including an inner labyrinth seal ring, an outer labyrinth seal ring, a radially inner bearing shield, and a radially outer bearing shield. The labyrinth seal forms an effective barrier against solid contaminants and also non-solid contaminants such as fluids.

### BACKGROUND OF THE INVENTION

1. Field of the Invention

The present invention relates to a labyrinth seal for an antifriction ball bearing.

2. Discussion of the Related Art

Bearings for rotatable machine parts operating in an environment containing dust, other dirt or moisture, biological fluids, etc., must be protected against such damaging media by effective seals to prevent the early destruction of the bearings. Gaskets may be used which frictionally engage the members. However, frictional losses will be encountered, the gaskets may soon wear out, and the surfaces subject to frictional engagement may require careful polishing which greatly increases the cost of the machinery.

Contact-free seals may not be subject to these disadvantages. However, they may not always be effective and may require a sealing medium filling the seal to be effective. Such seals may also require repeated servicing. It has also been proposed to use centrifugal force in such contact-free seals for preventing the penetration of dirt towards the bearing by such force and without the use of a sealing medium.

Referring to FIG. 1, electric spindle motors of the type used in disk drives conventionally use ball bearing assemblies 18 to facilitate movement between a rotary member 28 and a stationary member 26. Ball bearing assemblies 18 generally include balls 20 which are positioned between an inner bearing ring 22 and an outer bearing ring 24. Bearing assemblies 18 may be either inner or outer rotators depending on whether the hub 26 or shaft 28 rotates. For mechanisms using a rotating shaft, the inner bearing ring 22 rotates with the shaft. For mechanisms using a rotating hub, the outer bearing ring 24 rotates with the hub. The balls 20 are preferably evenly spaced within the inner and outer bearing rings 22 and 24. The balls 20 are generally held in this evenly spaced position by teeth of a ball cage (not shown).

Bearing lubricant fluid is used in bearing assemblies 18 to encourage free movement of the balls 20, inner bearing ring 22, and outer bearing ring 24. Conventionally, the lubricant is initially deposited on the balls, ring raceway and the ball cage. During operation, however, the lubricant tends to migrate and eventually may escape the bearing assembly 18. The lubricant that migrates and escapes the bearing assembly 18 often enters the interior of the motor or exits the motor completely.

The bearings of a drive shaft of a medical or dental treatment instrument or other handpiece for use in a medical laboratory or environment, are subject to relatively high speeds of rotation at which the driven drive shafts rotate. With these high rotational speeds, entry of contaminant materials, in particular into the bearing near the tool, must be prevented. Otherwise, the entry of contaminant material may lead to premature wear and failure of the bearing and thus of the treatment instrument. Examples of contaminant materials may include treatment fluids such as water, alcohol, and spray, and also body fluids such as blood and bone fragments. Such contaminant materials tend to migrate on the drive shaft towards the bearing, for example upon cleaning of the treatment site with water and/or spray, whereby such a treatment fluid reflected from the treatment site can easily enter into the housing of the medical or dental instrument and potentially penetrate further to the location of the bearing.

A further contributing factor to the bearing contamination problem may arise from the use of drive shafts which are driven by means of a turbine wheel attached to the drive shaft, for example, adjacent to a ball bearing. For instance, in dental instruments using a turbine, upon interruption of the propellant air (compressed gas) within the turbine housing, a reverse suction effect occurs because the rotor, which continues to run, generates a vacuum as a result of the switched off propellant air. This suction effect leads to an axial suction flow on the drive shaft to the two sides of the turbine wheel. Such a suction flow encourages the movement of contaminant materials towards the locations of the bearing. Aerosols which contain bacteria and the like can be sucked out of the oral cavity of a patient by the vacuum into the rotor housing. Upon subsequent switching on again of the propellant air, the aerosol components are conveyed out of the turbine space again, which is unhygienic and increases the danger of transfer of pathogens from patient to patient. In order to avoid these effects, various solutions have been proposed. However, these solutions tend to be complicated in design.

To address the sealing of a ball bearing such as used in the above-described turbine handpiece, a sealing arrangement for sealing the gap between the inner ring and the outer ring and the gap between the housing and the drive shaft is described in U.S. Pat. No. 5,676,543 to Lingenhole et al. With reference to FIG. 2, there is shown an angled dental drill handpiece in which a turbine wheel 5 arranged in the angled head 3 of the handpiece is arranged with the associated ball bearing assembly 11, and drive shaft 6/drilling tool (not shown).

A labyrinth seal 71 is arranged between the wall 7a of the housing 7 on the tool side, and on the drive shaft 6. The labyrinth seal 71 has two labyrinth-rings 72, 73 which engage over one another axially and also radially. The axially outer labyrinth ring 72 is attached to the drive shaft 6 by gluing or by welding.

The axially inner labyrinth ring 73 is attached non-rotatably to the housing wall 7a, or the labyrinth ring 73 is arranged in one piece on the outer ring of the ball bearing. Between the labyrinth rings 72, 73 there is a radial gap S1 by which the labyrinth is formed. The axially outer labyrinth ring 72 has on its outer periphery, and the axially inner labyrinth ring 73 has on its inner periphery, in each case a sleeve-like preferably hollow cylindrical axial ring extensions 74, 75. The ring extensions stand up axially towards one another and overlap, whereby the ring extension 74 of the axially forward labyrinth ring 72 engages over the ring extension 75 of the axially inner labyrinth ring 73 with a radial spacing forming the gap S1.

The above-described labyrinth seal 71 is used in combination with an axial seal 28 or covering of the associated ball bearing 11 (see also FIG. 3). The ball bearing seal 28 comprises in each case two disk-like blocking rings or sealing rings 31, 32 arranged axially one behind the other, which are each formed by means of a flat annular disk. The outer sealing ring 31 is fastened to the inner ring 34 by laser spot welding 33. The sealing ring 31 is part of a labyrinth seal having a second sealing ring 32 arranged inwardly of the sealing ring 31, which second sealing ring sits in a bore widening internal circumferential groove 43 bearing inwardly against a shoulder surface 44 and being restricted outwardly by a releasable securing ring 45 which is seated in an inner groove 43a. As is the outer sealing ring 31, the inner sealing ring 32 is also formed of a flat annular disk.

This configuration is complicated, has many components and is expensive to manufacture. The inner and outer seal rings 72, 73 require separate mounting to the shaft and housing, respectively. In commercially known dental instruments constructed according to this invention, the outer sealing ring 72 is laser spot welded on to the shaft, so that it is not possible in practice for a dentist, his/her assistant, or service technician to remove the shaft from the instrument and re-mount it again on the latter without great difficulty or possibly damaging the outer sealing ring 72 or laser spot weld. The shaft and instrument must therefore be cleaned and sterilized in the assembled state before using, which makes it difficult to clean and sterilize satisfactorily. Furthermore, to remove the drilling tool from the shaft requires applying torque to the shaft that may also damage the outer sealing ring 72 or laser spot weld. The outer sealing ring 72 must be manufactured with extreme precision and mounted properly. Any misalignment or variation in the outer sealing ring dimensions and location will cause the turbine assembly to become unbalanced at high speed. The unbalanced turbine will cause the ball bearing to fail prematurely. In use, commercially known dental instruments have shown failures of the laser spot welding of the outer sealing ring 72 due to the impulse loading of the instrument (on/off cycling). Finally, the device is comparatively expensive to manufacture because of the relatively large number of parts to be produced and connected with one another.

What is needed is a self-contained labyrinth seal ball bearing assembly to prevent or reduce the penetration of contaminants into a housing or into a ball bearing or bearings, of a disk drive, medical or dental treatment instrument of the kind indicated above, or other mechanical mechanism such as gyroscopes, cooling fans, molecular pumps, turbo chargers, laser scanner, etc.

It is therefore one of the objects of this invention to provide a simple self-contained labyrinth seal ball bearing assembly requiring a minimum of servicing with an enhanced operating life.

It is another object of the invention to provide such a self-contained labyrinth seal ball bearing assembly which may be readily manufactured and mounted and de-mounted with a minimum of expense.

It is also an object of the present invention to provide a labyrinth seal making use of centrifugal force for preventing the penetration of dirt and moisture and which is also effective against such penetration while the rotatable member stands still.

It is a more specific object of this invention to provide such a contact-free seal which may contain a sealing medium and which is so constructed that the sealing medium will not be removed by the centrifugal force.

### BRIEF DESCRIPTION OF THE DRAWINGS

FIG. 1 illustrates a prior art ball bearing assembly, shaft, and housing;

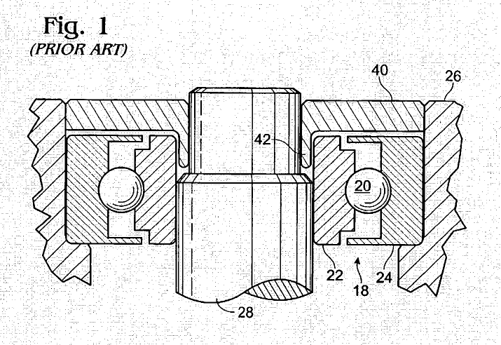

FIG. 2 illustrates a prior art dental handpiece;

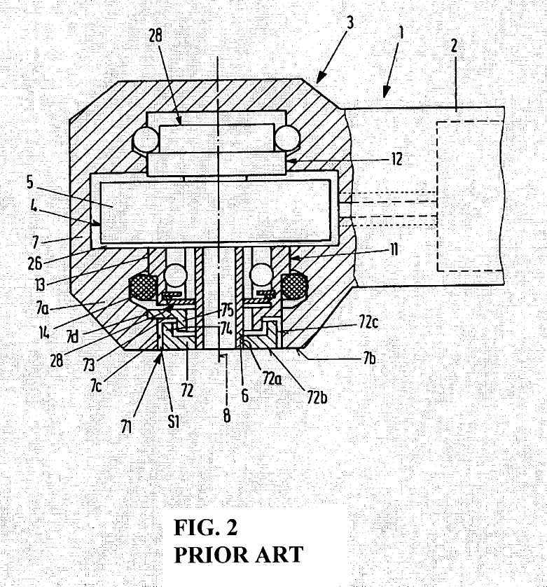

FIG. 3 illustrates a prior art ball bearing assembly used in a dental handpiece;

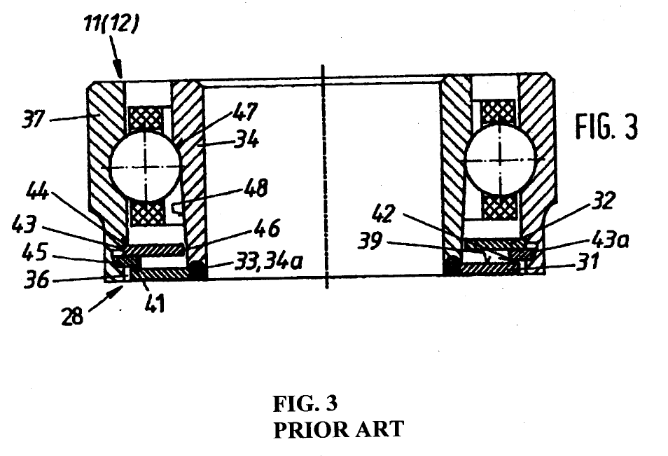

FIG. 4 illustrates a self-contained labyrinth seal ball bearing assembly using mirror image labyrinth seals according to embodiments of the present invention;

FIG. 5 illustrates a modified configuration of the self-contained labyrinth seal ball bearing assembly using an inboard shield according to embodiments of the present invention; and

FIG. 6 illustrates a modified configuration of the self-contained labyrinth seal ball bearing assembly according to embodiments of the present invention.

### DETAILED DESCRIPTION

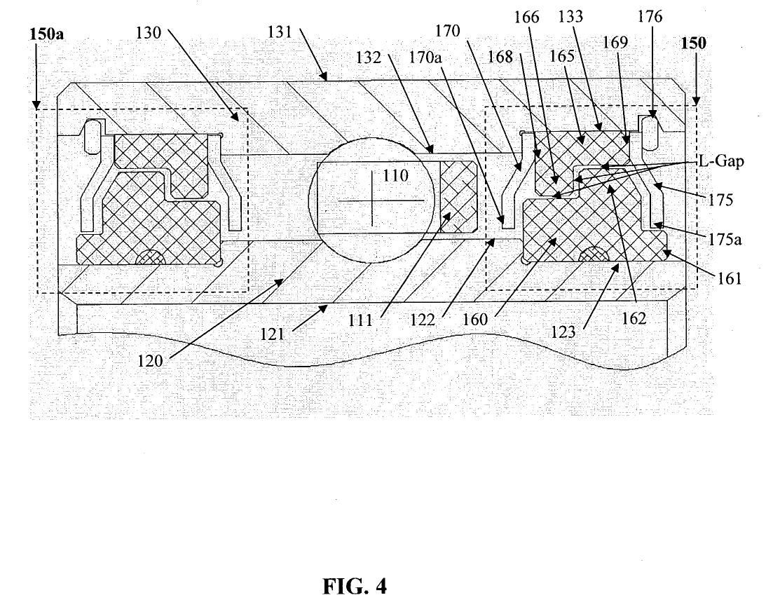

A self-contained labyrinth seal ball bearing assembly according to embodiments of the present invention is shown in FIG. 4. The self-contained labyrinth seal ball bearing assembly 100 includes a plurality of metallic or ceramic balls 110 which are positioned between a cylindrical inner bearing ring 120 and a cylindrical outer bearing ring 130. In an embodiment of the invention, the inner bearing ring 120 has an inner ring surface 121 that may be substantially adjacent a rotatable shaft, and the outer bearing ring 130 has an outer ring surface 131 that may be adjacent a housing.

In an alternative embodiment of the invention, the inner bearing ring 120 has an inner ring surface 121 adjacent a shaft, and the outer bearing ring 130 has an outer ring surface 131 adjacent a hub. Because the inner bearing ring 120 and the outer bearing ring 130 can rotate freely relative to each other, either the shaft or the hub can rotate depending on the design of the machine or mechanism using the bearing. Bearing assemblies 100 may be either inner or outer rotators depending on whether the hub or shaft rotates. For mechanisms using a rotating shaft, the inner bearing ring 120 rotates with the shaft. For mechanisms using a rotating hub, the outer bearing ring 130 rotates with the hub. The ball bearings 110 are preferably evenly spaced within the inner and outer cylindrical bearing rings 120, 130. The ball bearings 110 are generally held in this evenly spaced position by teeth of a ball cage 111.

The self-contained labyrinth seal ball bearing assembly 100 according to an embodiment of the present invention further includes a labyrinth seal 150 including an inner labyrinth seal ring 160, an outer labyrinth seal ring 165, a radially inner bearing shield 170, and a radially outer bearing shield 175. The labyrinth seal 150 forms an effective barrier against solid contaminants and also non-solid contaminants such as fluids.

In the embodiment according to FIG. 4, the labyrinth seal 150 is arranged between the inner bearing ring 120 and outer bearing ring 130. The labyrinth seal 150 has two labyrinth seal rings 160, 165 which are in close proximity (for example, 0.005 inches) of one another axially and preferably also radially. The labyrinth seal rings 160, 165 may be made of a thermoplastic material, e.g. Delrin, or preferably of a metal, e.g. stainless steel. The radially inner labyrinth seal ring 160 (axially outer) is arranged fixedly on the outer surface 122 of the inner bearing ring 120 and is attached, for example, by being press fitted, glued or welded. The radially inner labyrinth seal ring 160 (axially outer) may also include an axially outer extension 161 that extends away from the ball bearing 110, the function of which is described below. The radially outer labyrinth seal ring 165 (axially inner) is arranged fixedly on the inner surface 132 of the outer bearing ring 130 and is also attached, for example, by being press fitted, glued, or welded, or by a retaining ring 176.

The inner labyrinth ring 160 and the outer labyrinth ring 165 may be set into step-like bore widenings 123, 133 into which the inner peripheral surface of the inner labyrinth ring 160 and the outer peripheral surface of the outer labyrinth ring 165 are fixedly attached. Between the labyrinth rings 160, 165 there is provided a small gap L-Gap (for example, approximately 0.005 inches) by which the labyrinth path is formed. Preferably the inner labyrinth ring 160 (axially outer) has on its outer periphery, and the outer labyrinth ring 165 (axially inner) has on its inner periphery, sleeve-like cylindrical radial ring extensions 162, 166 which ring extensions stand up radially towards one another and overlap both radially and axially. The ring extension 162 of the inner labyrinth ring 160 is in close contact with, but does not abut, the ring extension 166 of the outer labyrinth ring 165 thus forming the gap L-Gap. By this configuration there is provided the S-like axially and radially running labyrinth path.

The labyrinth seal 100, as shown in FIG. 4, further includes a cylindrically shaped axially inner bearing shield 170 and a cylindrically shaped axially outer bearing shield 175. The inner bearing shield 170 and outer bearing shield 175 may be fixedly attached to the outer labyrinth ring 165 on inner and outer radial surfaces 168, 169, respectively. The retaining ring 176 may hold the inner bearing shield 170, the outer bearing shield 175, and the outer labyrinth ring 165 in place against the inner surface 132 of the outer bearing ring 130.

The radially inner surface 175a of the cylindrically shaped axially outer bearing shield 175 is in close proximity, but does not abut, the axially outer extension 161 of the radially inner labyrinth seal ring 160, thus contributing to the labyrinth seal effect. The radially inner surface 170a of the cylindrically shaped axially inner bearing shield 170 is in close proximity, but does not abut, the inner ring surface 122 of the inner bearing ring 120, thus also contributing to the labyrinth seal effect.

Various parts used in accordance with embodiments of the present invention may have additional functions or functionally combine or supplement one another. For example, the cylindrically shaped axially outer bearing shield 175 forms a blocking shield and a centrifugal ring because the outer bearing ring 130 to which it is attached may be directly or indirectly connected with a drive shaft or hub and thus is subjected to rotation. The cylindrically shaped axially outer bearing shield 175 forms with its outer side surface a centrifugal surface on which, upon rotation of the hub, contaminants are radially centrifugally ejected. It is thus also a centrifugal ring. It is therefore of advantage to make radial dimensions of the cylindrically shaped axially outer bearing shield 175 as great as possible, and to form the shield in the shape of a disk so that a considerable centrifugal effect is achieved.

The cylindrically shaped axially inner and outer bearing shields 170, 175 may be made of plastics material or preferably of metal e.g., steel, whereby they abut sealingly with their peripheral sections against the associated abutting parts. This form a sealing shield or blocking shields, blocking peripheral sections of which have a slight axial or radial spacing (play) from the neighboring components to define a gap, whereby a covering or a labyrinth gap is provided.

For the above-described embodiment of FIG. 4, it is advantageous to also provide the bearing assembly 100 on the side away from a tool with a corresponding labyrinth seal 150a, in mirror-image fashion, in order to prevent or reduce on this side the penetration of contamination. This is particularly the case for such housings or assemblies having on their side away from the tool, a semi-exposed or permanently exposed opening.

Therefore, the embodiment of the present invention according to FIG. 4 further includes a mirror image labyrinth seal 150a located on the opposite side of the ball bearing 110. Labyrinth seal 150 and mirror image labyrinth seal 150a provide the self-contained labyrinth seal ball bearing assembly 100 with a symmetrical arrangement wherein the bearing may be installed in applications where the bearing is exposed to contaminates on both sides of the bearing assembly 100.

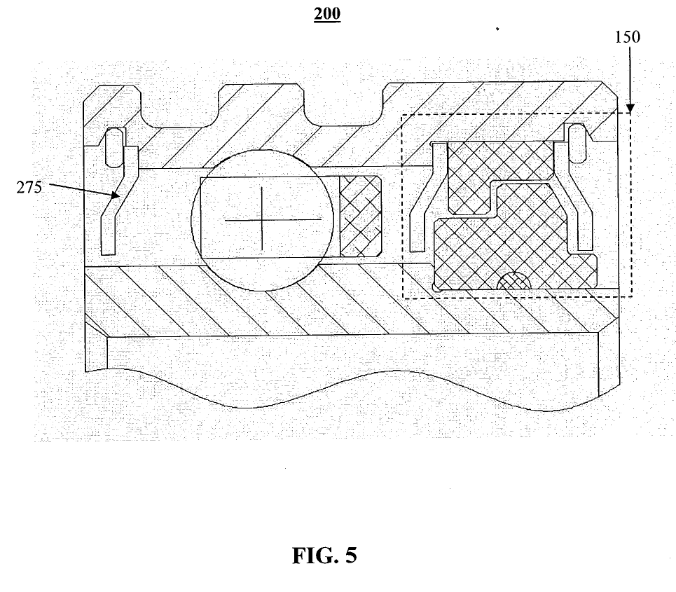

In an alternative embodiment of the present invention according to FIG. 5, a cylindrically shaped axially outer bearing shield 275 (inboard shield) is used in place of mirror image labyrinth seal 150a. This embodiment may be used where the side of the bearing assembly closest to cylindrically shaped axially outer bearing shield 275 is in abutment with a housing, wall, etc., i.e. a bearing assembly not exposed to contaminates on both sides of the bearing assembly.

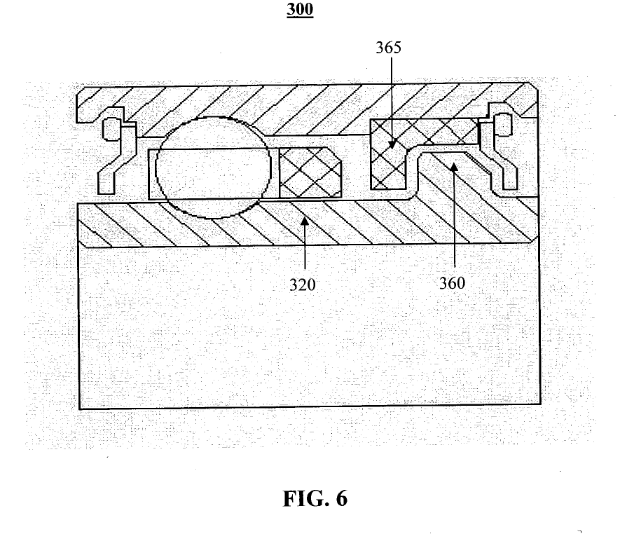

In FIG. 6, there is shown a modified configuration or arrangement of the self-contained labyrinth seal ball bearing assembly. In the modification shown in FIG. 6, the inner labyrinth seal ring 360 is arranged in one piece as part of the inner bearing ring 320 of the ball bearing assembly 300. With this configuration, the labyrinth seal ring 360 can be prefabricated on the inner bearing 320 of the ball bearing assembly 300. Also, the outer labyrinth seal ring 365 is modified to extend radially towards the inner bearing ring 320 to eliminate the use of an inner bearing shield.

The above-described arrangement of the self-contained labyrinth seal ball bearing assemblies 100, 200, 300 also prevents an unintended dismounting/disassembly of the ball bearing assemblies 100, 200, 300. Thus, upon dismounting of a drive shaft, it is not necessary to prevent the ball bearings assemblies 100, 200, 300 from falling apart.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A ball bearing assembly having a labyrinth seal, comprising:
an outer ring having a radially inner surface;
an inner ring having a radially outer surface facing said inner surface of said outer ring, said inner ring or said outer ring being in association with a rotatable component;
at least one ball bearing disposed between said inner ring and said outer ring;
at least one labyrinth seal disposed between the inner ring and the outer ring, said labyrinth seal including an inner labyrinth ring, and an outer labyrinth ring, said inner and outer labyrinth rings having ring extensions extending radially toward one another and defining at least one radial gap between said rings, the inner labyrinth ring being associated with the inner ring, and the outer labyrinth ring being associated with the outer ring, wherein the inner and outer labyrinth rings overlap both radially and axially,
an inner shield,
and an outer shield; and
an inboard shield.

2. The ball bearing assembly according to claim 1, wherein the inner and outer labyrinth ring are made of a material from the group consisting of steel, plastic, or thermoplastic.

3. The ball bearing assembly according to claim 1, wherein the inner shield and the outer shield are in association with the outer labyrinth ring.

4. The ball bearing assembly according to claim 1, wherein the inboard shield is in association with the outer labyrinth ring.

5. A ball bearing assembly having a labyrinth seal, comprising:
an outer ring in association with a housing, said outer ring having a radially inner surface;
an inner ring in association with a drive shaft and able to rotate with said drive shaft, said inner ring having a radially outer surface facing said inner surface of said outer ring;
at least one ball bearing disposed between said inner ring and said outer ring and disposed around the rotatable drive shaft;
at least one labyrinth seal disposed between the inner ring and the outer ring, said labyrinth seal including two labyrinth rings having ring extensions extending radially toward one another and defining at least one radial gap between said rings, the inner labyrinth ring being associated with the rotatable inner ring, and the outer labyrinth ring being associated with the outer ring, wherein the inner and outer labyrinth rings overlap both radially and axially,
an inner shield,
and an outer shield; and
an inboard shield.

6. The ball bearing assembly according to claim 5, wherein the inner and outer labyrinth ring are made of a material from the group consisting of steel, plastic, or thermoplastic.

7. The ball bearing assembly according to claim 5, wherein the inner shield and the outer shield are in association with the outer labyrinth ring.

8. The ball bearing assembly according to claim 5, wherein the inboard shield is in association with the outer labyrinth ring.

9. A ball bearing assembly having a labyrinth seal, comprising:
an outer ring having a radially inner surface;
an inner ring having a radially outer surface facing said inner surface of said outer ring, said inner ring or said outer ring being in association with a rotatable component;
at least one ball bearing disposed between said inner ring and said outer ring;
at least one labyrinth seal disposed between the inner ring and the outer ring, said labyrinth seal including an inner labyrinth ring, and an outer labyrinth ring, said inner and outer labyrinth rings having ring extensions extending radially toward one another and defining at least one radial gap between said rings, the inner labyrinth ring being associated with the inner ring, the outer labyrinth ring being associated with the outer ring, wherein the inner and outer labyrinth rings overlap both radially and axially,
an inner shield,
and an outer shield.

10. The ball bearing assembly according to claim 9, wherein the inner and outer labyrinth ring are made of a material from the group consisting of steel, plastic, or thermoplastic.

11. The ball bearing assembly according to claim 9, wherein the inner shield and the outer shield are in association with the outer labyrinth ring.

12. The ball bearing assembly according to claim 9, wherein the inner labyrinth ring and the inner ring are a unitary piece.

13. A roller bearing assembly having a labyrinth seal, comprising:
an outer ring in association with a housing, said outer ring having a radially inner surface;
an inner ring in association with a drive shaft and rotatable with said drive shaft, said inner ring having a radially outer surface facing said inner surface of said outer ring;
at least one ball bearing disposed between said inner ring and said outer ring and disposed around the rotatable drive shaft; and
at least one labyrinth seal disposed between the inner ring and the outer ring, said labyrinth seal including two labyrinth rings each having ring extensions extending radially toward one another and defining at least one radial gap between said rings, the inner labyrinth ring being associated with the rotatable inner ring, and the outer labyrinth ring being associated with the outer ring, wherein ring extensions of the inner and outer labyrinth rings overlap both radially and axially,
an inner shield,
and an outer shield.

14. The ball bearing assembly according to claim 13, wherein the inner and outer labyrinth ring are made of a material from the group consisting of steel, plastic, or thermoplastic.

15. The ball bearing assembly according to claim 13, wherein the inner shield and the outer shield are in association with the outer labyrinth ring.

16. The ball bearing assembly according to claim 13, wherein the inner labyrinth ring and the inner ring are a unitary piece.
